(19) United States
(12) Patent Application Publication
(10) Pub. No.: US 2016/0148157 A1
(43) Pub. Date: May 26, 2016

(54) MANAGING ACTIVITIES IN AN ORGANIZATION

(71) Applicant: SANJU WALIA, Rohtak (IN)

(72) Inventor: SANJU WALIA, Rohtak (IN)

(21) Appl. No.: 14/552,482

(22) Filed: Nov. 25, 2014

(51) Int. Cl. G06Q 10/10; G06F 3/0484; H04L 29/08

(52) U.S. Cl. CPC G06Q 10/101; H04L 67/18; G06Q 10/107; G06F 3/04842; G06F 3/04847

(57) ABSTRACT

Methods and system are disclosed that assist in executing tasks related to managing activities in an organization, in one aspect, a user interface is provided via a collaborative application to receive input credentials of a user. Upon receiving the input credentials, the collaborative application provides another interface that renders a list of activities that the user is authorized to view. From the rendered list of activities, the user selects an activity. Upon selecting the activity, the collaborative application determines a correspondence between the selected activity, dashboards, user interfaces, user interfaces elements, etc. associated with the selected activity, A dashboard associated with the selected activity may be instantiated that may be used to manage the selected activity via the collaborative application.

### BACKGROUND

In multinational organizations, multiple teams may collaborate with each other to develop software applications. In this scenario, the development of software application may necessitate an interaction and coordination between the team members across geographies. Even when the team members are collocated, such co-ordination and interaction may be challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings,

FIG. 1 is a block diagram illustrating an environment including a collaborative application in communication with a data store, according to an embodiment,

FIG. 2 is a flow diagram illustrating a process to manage activities in an organization, according to an embodiment.

FIG. 3A is a block diagram showing a user interface provided by a collaboration application, according to an embodiment.

FIG. 3B is a block diagram showing a user interface provided by a collaborative application, according to an embodiment.

FIG. 3C is a block diagram showing a user interface provided by a collaborative application, according to an embodiment,

FIG. 4 is a block diagram showing an e-mail template generated by an e-mail service working with a collaborative application, according to an embodiment.

FIG. 5 is a block diagram showing a user interface provided by a collaborative application, according to an embodiment.

FIG. 6A is a block diagram showing a user interface provided by a collaborative application, according to an embodiment,

FIG. 6B is a block diagram showing a user interface provided by a collaborative application, according to an embodiment.

FIG. 7A is a block diagram showing a user interface provided by a collaborative application, according to an embodiment,

FIG. 7B is a block diagram showing a context menu associated with a tool bar of a dashboard, according to an embodiment.

FIG. 7C is a block diagram showing a context menu associated with a tool bar of a dashboard, according to an embodiment.

FIG. 7D is a block diagram showing a context menu associated with a tool bar of a dashboard, according to an embodiment.

FIG. 7E is a block diagram showing a user interface provided by a collaborative application, according to an embodiment,

FIG. 7F is a block diagram showing a user interface element rendered on a dashboard of a collaborative application, according to an embodiment.

FIG. 7G is a block diagram showing a user interface provided by a collaborative application, according to an embodiment.

FIG. 7H is a table showing exemplary information associated with an activity, according to an embodiment.

FIG. 7I is a block diagram showing user interface provided by a collaborative application, according to an embodiment.

FIG. 8 is a block diagram of a computer system, according to an embodiment

### DETAILED DESCRIPTION

Embodiments of techniques related to managing activities in an organization are described herein in the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Technological advancements have propelled a demand for integrated applications to meet increasing business needs. For instance, integrated applications may provide a virtual platform, where employees of an organization can collaborate to work and manage projects, manage human resource, schedule and manage activities, etc. In addition, integrated applications may provide virtual platforms for sharing views, opinions, feedbacks, etc., on organizational policies, projects, activities, etc., that may be anonymous.

Typically, software development organizations may provide software development and engineering services. A software development organization may adopt methodologies or models for execution of software development processes. By way of example, the process methodologies or models may include agile model, waterfall model, iterative and incremental development model, spiral development model, prototyping model, etc. The process methodologies may include distinct phases and activities that may facilitate better planning and management of the software development.

For example, consider a software development organization adopting agile model for software development, including iterative and incremental phases for managing software application and/or product development. Such iterative and incremental phases may be referred to as scrum, where a software development team self-organizes by physical co-location or online collaboration of the team members. Serum may define a flexible and holistic approach towards the software application and/or product development strategy, where the development team may challenge assumptions of the traditional approaches for developing the software application and/or product.

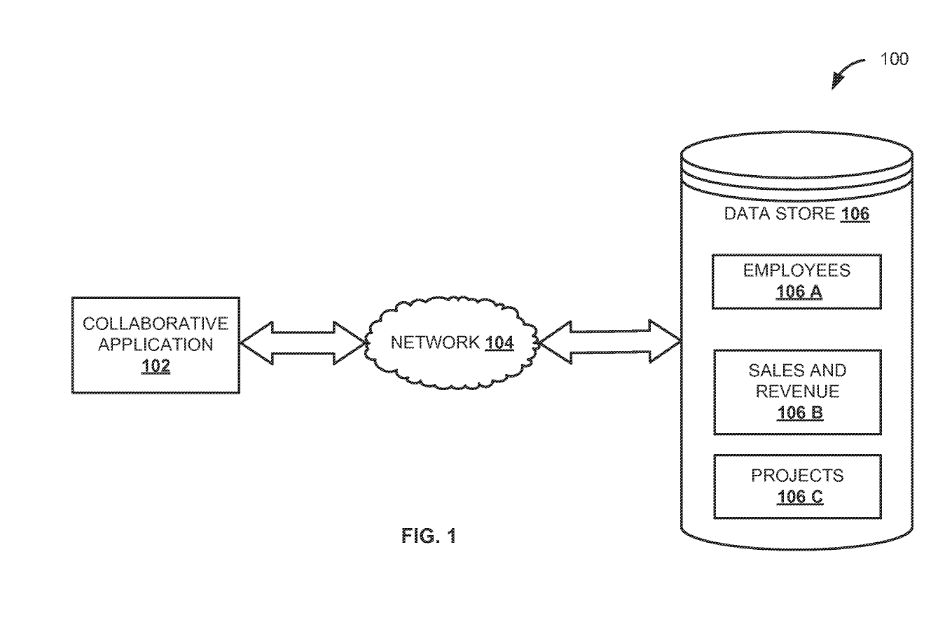

FIG. 1 is a block diagram illustrating environment 100 including a collaborative application in communication with a data store, according to an embodiment. By way of illustration, FIG. 1 shows collaborative application 102 in communication with data store 106 over network 104. In an embodiment, collaborative application 102 may provide dashboards, user interfaces, user interface elements, graphical control elements, application launchers, animated graphical elements, icons, etc. (not shown), that may be integrated to concurrently work together. In an embodiment, the collaborative application may be deployed in an on-premise computing environment and/or a distributed computing environment (e,g., cloud computing environment). When deployed in the cloud computing environment, collaborative application 102 may share computing resources, frameworks, infrastructure, etc. (e.g., memory, storage, data processors, etc.) to increase the functional coherency to offer shared services. The collaborative application 102 may provide a virtual platform for managing employee engagement and participation, providing an interface where an employee may therefore provide an opinion (e.g., views, thoughts, feedbacks, etc.) on organizational policies, events, activities, about a product or a service, team building activities, etc., in a streamlined and centralized way.

In an embodiment, data store 106 may store business data. The business data may be stored in a centralized data store or multiple data stores that may be geographically distributed. Such business data may be accessed by systems and applications in the organization over network 104. The business data may be structured or unstructured, and stored in data structures (for e.g., tables, flat files, spreadsheets, business objects, etc.) in the data stores. By way of example, the business data stored in data store 106 may include information related to: employees 106A of the organization, products and services offered by the organization (not shown), marketing (not shown), sales and revenues information 106B, information related to projects 106C in progress and in pipeline), activities, such as, offsite meetings, product development or engineering services related team meetings, etc, (not shown),

In an embodiment, an end user may manage activities in the organization using collaborative application 102. The collaborative application 102 may communicate with data store 106 by establishing a connection with data store 106 over network 104 and access business data stored therein. A user may register with collaborative application 102 to manage the activities in the organization. In an embodiment, collaborative application 102 may provide user interfaces to: receive input credentials of an end user, render a list of activities the end user is authorized to view and/or manage, render information related to activities, etc. Upon selecting an activity from the rendered list of activities, collaborative application 102 may determine a correspondence between the selected activity, dashboards, user interfaces (e.g., associated user interfaces with the selected activity), user interface elements (e.g., associated user interface elements with the selected activity), etc. The selected activity may be managed by instantiating the associated dashboard via collaborative application 102.

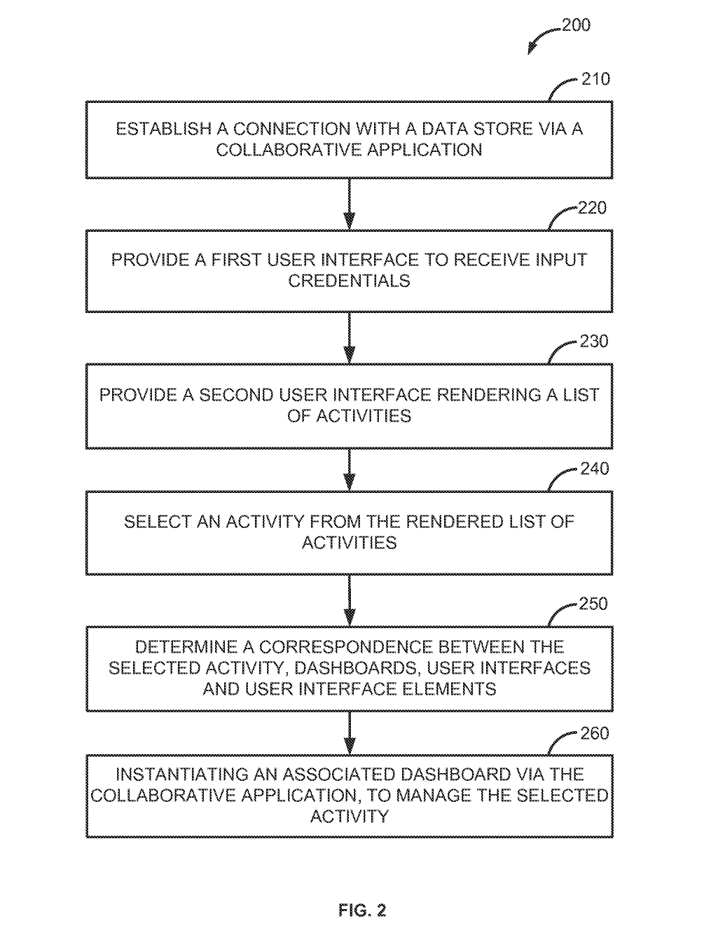

FIG. 2 is a flow diagram illustrating process 200 to manage activities in an organization, according to an embodiment. Process 200, upon execution, may facilitate managing activities in an organization by a collaborative application. In an embodiment, the collaborative application may bring together multiple teams and users in the organization by providing a common platform for interaction. The collaborative application may be in communication with a central data store or multiple data stores storing business data. For example, a data store may correspond to one or more of a web-based database, a relational database, a hierarchical database, a network database, an object oriented database, an in-memory database, a virtual private database, a real-time database, etc.

In an embodiment, consider a team of employees collaborating in an organization for developing a software application for a customer. By way of example, the team adapts to agile software development process (e.g., according to Agile Manifesto) methodology for developing the software application. The agile software development process methodology may include iterative and incremental phases for developing the software application. In such a scenario, the team developing the software application may need to coordinate and effectively communicate during the entire process of the software development life cycle. By way of example, the software development life cycle may include activities, such as, gathering business and technical requirements, specification, architecture, design, development, testing, debugging, deployment, maintenance, etc. In an embodiment, the team for developing the software application includes individuals with defined roles, such as, a product owner, a product designer, software application developers, software application testers, a scrum master, etc.

In an embodiment, the product owner may be responsible for defining and communicating the software application requirements to the team. The software application developers, software application testers, etc., may be responsible for the actual work (for e.g., analyze, design, develop, test, document, etc.). The scrum master may be responsible for communicating and coordinating with the team members, to ensure that the team timely builds and delivers the software application. The scrum master may enforce the rules of scrum, may often chair key meetings, gathers opinions and suggestions from the team members for process/product improvement, etc. In an embodiment, upon gathering and analyzing the business and technical requirements, the team may devise steps to develop the software application.

By way of example, “John Smith” is a scrum master of the team that is developing the software application, “John Smith” coordinates and manages activities for developing the software application by using an online collaborative application. In an embodiment, coordinating and managing activities may include setting up an agenda for scheduling meetings with the team members; inviting the team members to the meeting; communicating on the progress of the software application development; receiving updates from the team members on the progress of the software application development; brain storming with the team members to assimilate inputs from the team members on feature enhancements and/or improvements and/or functionalities associated with the software application, etc.

in an embodiment, “John Smith” may execute such activities by using the collaborative application. The collaborative application may communicate with a data store by establishing a connection with the data store, at 210. In an embodiment, to manage the activities associated with the software development, “John Smith” may access and instantiate the collaborative application. Upon instantiation, the collaborative application may provide a user interface to register user credentials (e.g., a user name, a. password, an e-mail address, etc.). The registered user credentials may be stored in the data store and may be used as input credentials to login to the collaborative application. The registered user may be authorized to login into the collaborative application to manage activities in the organization.

In an embodiment, upon registering arid storing the credentials in the data store, an electronic mail (e-mail) service working in conjunction with the collaborative application may be triggered to send a notification (e.g., an e-mail) to “John Smith.” The content of the e-mail sent to “John Smith” may include the input credentials that were registered with the collaborative application, that may be used to login into the collaborative application. Subsequently, when the collaborative application is accessed, a user interface (e.g., a first user interface) to receive the input credentials is provided at 220, by the collaborative application. “John Smith” may enter his input credentials (e.g., a user name, a password, an e-mail address, etc.) to login into the collaborative application.

In an embodiment, based on attributes associated with the input credentials, the collaborative application, at 230, provides another user interface (e.g., second user interface) that renders a list of activities. The second user interface rendering the list of activities may include creating a new activity, a search bar to search for the activities, etc. In an embodiment, when “John Smith” has administrative privileges, he may be authorized to create a new activity. The administrative privileges may be controlled by attributes associated with the input credentials. The attributes associated with the input credentials may be used to control access to business information (e.g., access control) and visibility of information to “John Smith.” In an embodiment, the second user interface renders the list of activities that “John Smith” is authorized to view, On the second user interface, an activity from the rendered list of activities is selected, at 240.

Upon receiving a selection, the collaborative application determines a correspondence between the selected activity, the dashboards, the user interfaces, and user interface elements, at 250. In an embodiment, determining the correspondence between the selected activity, the dashboards, the user interfaces, the user interface elements, etc., may include determining attributes and identifiers; (e.g., input credentials, activity code, business unit code, project code, project team code, etc.) with the selected activity, the dashboards, the user interfaces, the user interface elements, etc. Similarity between the attributes and identifiers (e.g. identical identifiers and identical attributes) of the elements (e.g., dashboards, user interfaces, user interface elements, etc.) may be determined by matching the attributes and identifiers with each other. Matching to determine the similarity between the identifiers and the attributes may include comparing the attributes and the identifiers.

By way of example, when the identifier associated with the selected activity is ‘ABC’, the collaborative application may search for the elements (e.g., dashboards, user interfaces, user interface elements, etc.) that have identical identifiers (e.g., ‘ABC’). In an embodiment, upon selecting the activity with the identifier ‘ABC’, the collaborative application searches for the elements, determines the identifiers associated with the elements; compares the identifiers to determine a match; filters and selects the elements to be displayed.

In an embodiment, upon determining the identical identifiers, a dashboard associated is instantiated via the collaborative application to manage the selected activity, at 260. The dashboard may include additional user interfaces, user interface elements (for e.g., graphical control elements, application launchers, animated or static graphical elements, icons, labels, etc.) buttons, text boxes, a tool bar including graphical elements for specific functionalities, etc. The graphical elements in the tool bar may be used to navigate to different dashboards; refresh the dashboard to include updated content or information; access information related to team members associated with the selected activity; add information (e.g., comments, suggestions, feedbacks, etc., that may appear as color coded post-it note, stickers, etc.; consolidate information about the meeting/activity and send the consolidated information via e-mail to the team members associated with the selected activity; download updates and information related to the progress with project, etc. In an embodiment, “John Smith” manages the selected activity via the associated dashboard instantiated by the collaborative application.

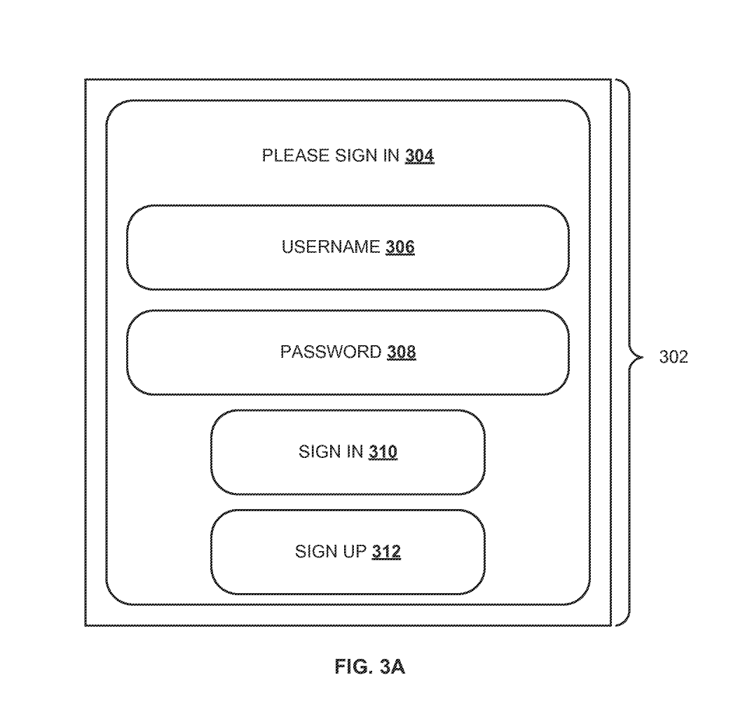

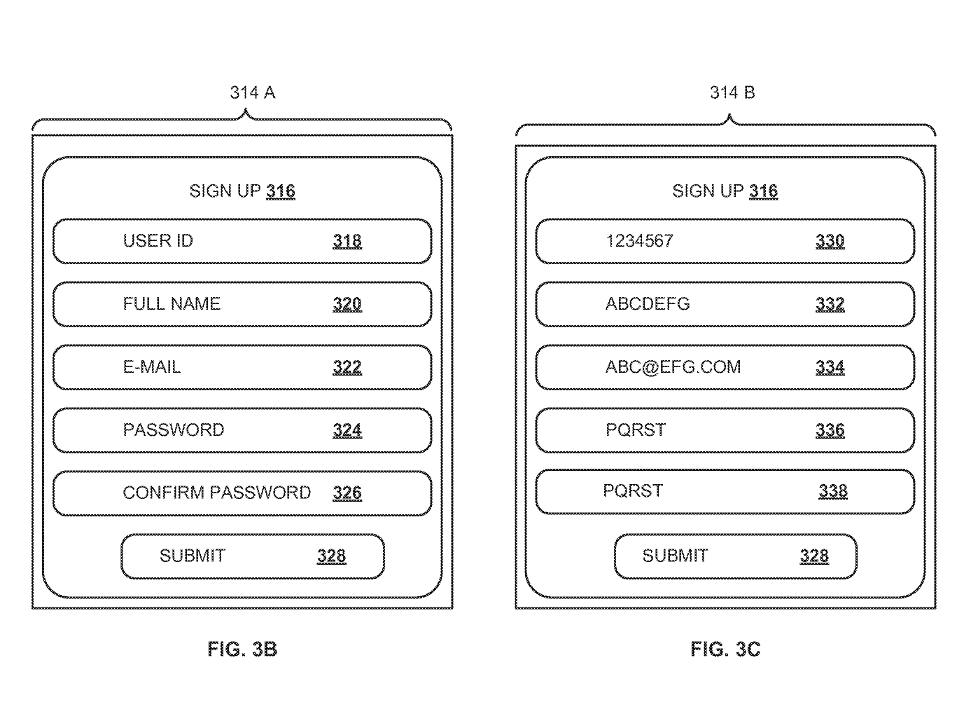

FIG. 3A is a block diagram showing a user interface provided by a collaboration application, according to an embodiment. By way of illustration, FIG. 3A shows user interface 302 that is instantiated on accessing the collaborative application. In an embodiment, the collaborative application may provide user interface 302 to sign in or login (e.g., indicated by title “PLEASE SIGN IN” 304) into the collaborative application. A user, when already registered with the collaborative application, may enter his/her input credentials in 306 and 308 and click on 310 to login into the collaborative application. In an embodiment, a user, when not registered with the collaborative application, may register his/her credentials (e.g., username 306, password 308, etc.) with the collaborative application by clicking on 312.

FIG. 3B is a block diagram showing a user interface provided by a collaborative application, according to an embodiment. In an embodiment, upon clicking on 312 (e.g., “SIGN UP” button in FIG. 3A), the collaborative application provides user interface 314A. By way of illustration, FIG. 3B shows that user interface 314A (e.g., indicated by “SIGN UP” 316) includes data fields to receive input credentials that may be used to register with the collaborative application. FIG. 3B shows user interface 314A that includes data fields (e.g., text boxes), such as, “USER ID” 318, “FULL NAME” 320, “E-MAIL” 322, “PASSWORD” 324, “CONFIRM PASSWORD” 326. Upon entering the credentials in the respective data fields and clicking “SUBMIT” 328, the input credentials may be saved to the data store.

FIG. 3C is a block diagram showing a user interface provided by a collaborative application, according to an embodiment. By way of illustration, FIG. 3C shows user interface 314B to register user credentials (e.g., indicated by “SIGN UP” 316) with the collaborative application. FIG. 3C shows values in the respective data fields, such as, “1234567” 330 (e.g., USER ID), “ABCDEFG” 332 (e.g., FULL NAME), “ABC@EFG.COM” 334 (e.g., E-MAIL), “PQRST” 336 (e.g., PASSWORD), “PQRST” 338 (e.g., CONFIRM PASSWORD) in the respective data fields. Upon clicking on “SUBMIT” 328, the user credentials (e.g., input credentials) may be saved to the data store via the collaborative application.

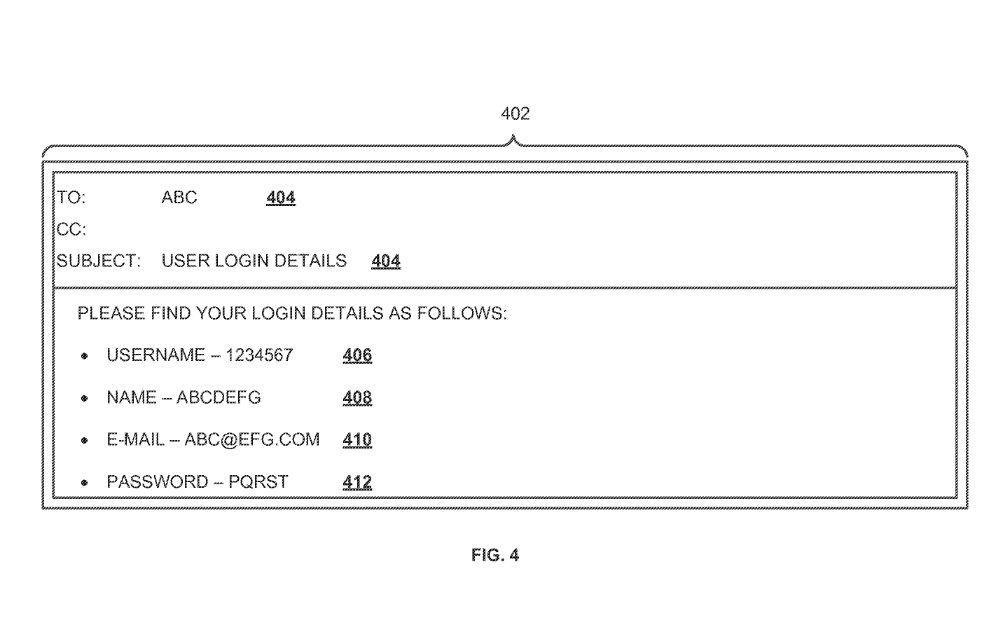

FIG. 4 is a block diagram showing an e-mail template generated by an e-mail service working with a collaborative application, according to an embodiment. By way of illustration, FIG. 4 shows an e-mail template 402 that is generated by an e-mail service that works in conjunction with the collaborative application. As explained previously, the e-mail template 402 including user login details 404 may be sent to a user (e.g., “ABC” 404) registered with the collaborative application. The e-mail template 402 includes login details, such as, “USERNAME” 406, “NAME” 408, “E-MAIL” 410, “PASSWORD” 412, etc.

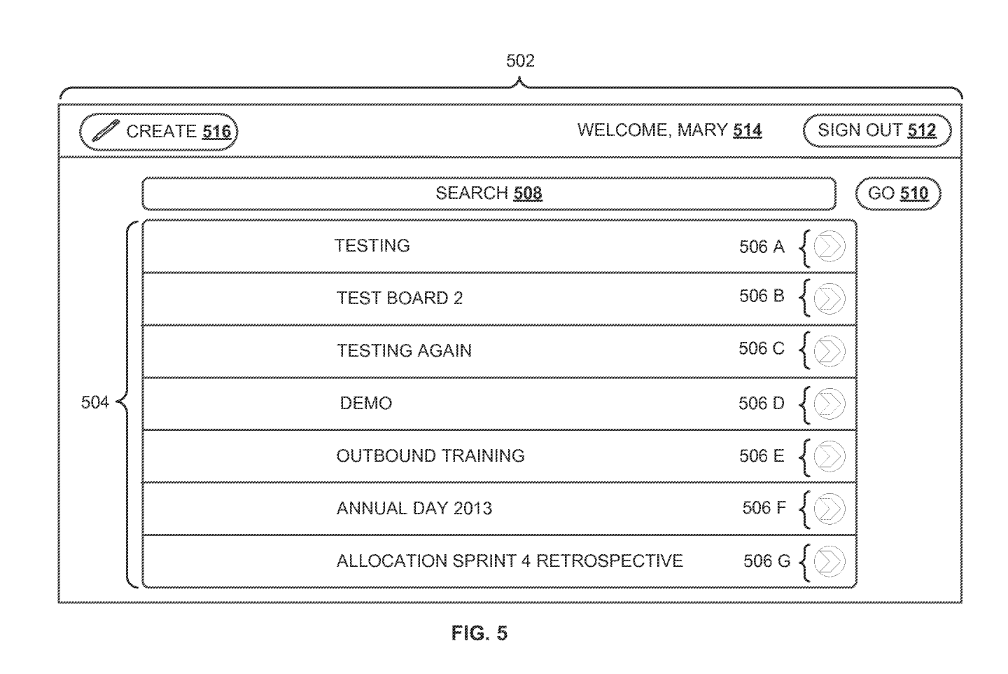

FIG. 5 is a block diagram showing a user interface provided by a collaborative application, according to an embodiment. In an embodiment, upon entering the input credentials in their respective data fields (e.g., “USERNAME” 306 and “PASSWORD” 308 of FIG. 3A) and clicking on “SIGNIN” 310, the user may be logged into the collaborative application. As explained previously, based on the attributes associated with the input credentials, the collaborative application provides user interface 502 rendering a list of activities 504. From the rendered list of activities 504, the user (e.g., “MARY” 514) may select an activity by clicking on the activity re,g., click on any of 506A, 506B, 506C, 506D, 506E, 506F, 506G) to navigate and access details associated with the activity. Upon selecting the activity, the collaborative application may instantiate a dashboard including user interfaces, user interface elements, etc., associated with the activity.

In an embodiment, user interface 502 provides a search bar (e.g., “SEARCH” 508) to search for activities. Upon entering the details in the search bar, the user may click on “GO” 510 to perform a search from the rendered list of activities. The collaborative application may execute the searching process to search the activity. FIG. 5 shows that the user interface 502 displays a user interface element that includes name of the user (e.g., “WELCOME, MARY” 514) who is logged into the collaborative application. The user may sign out of the collaborative application by clicking on “SIGN-OUT” 512. When the user has administrative privileges, he/she may create a new activity by clicking on “CREATE” 516. As explained previously, the administrative privileges may be controlled by attributes associated with the input credentials.

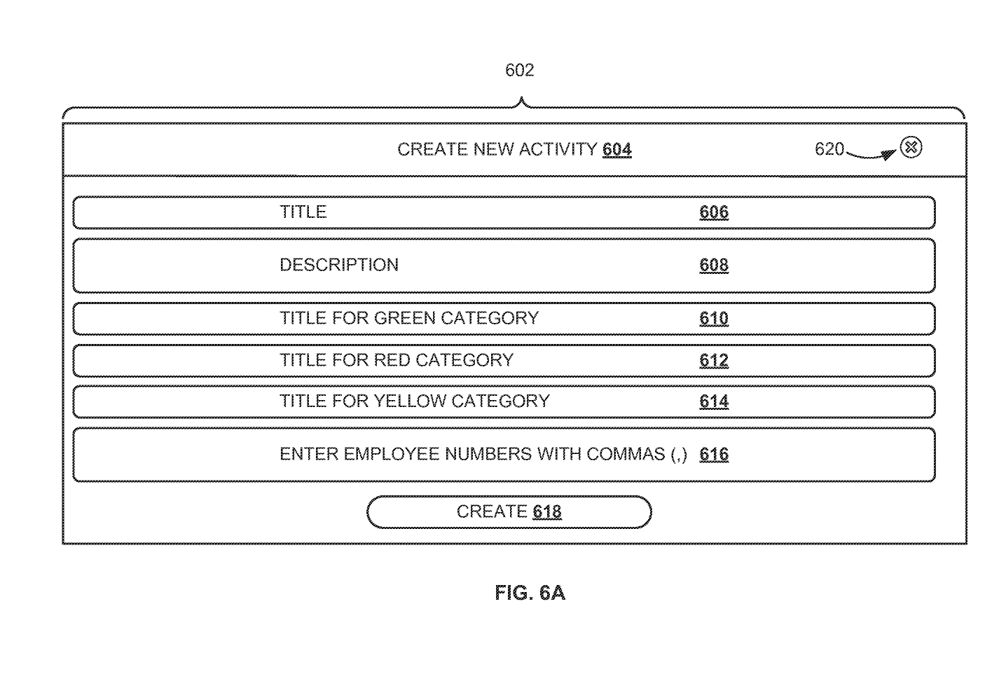

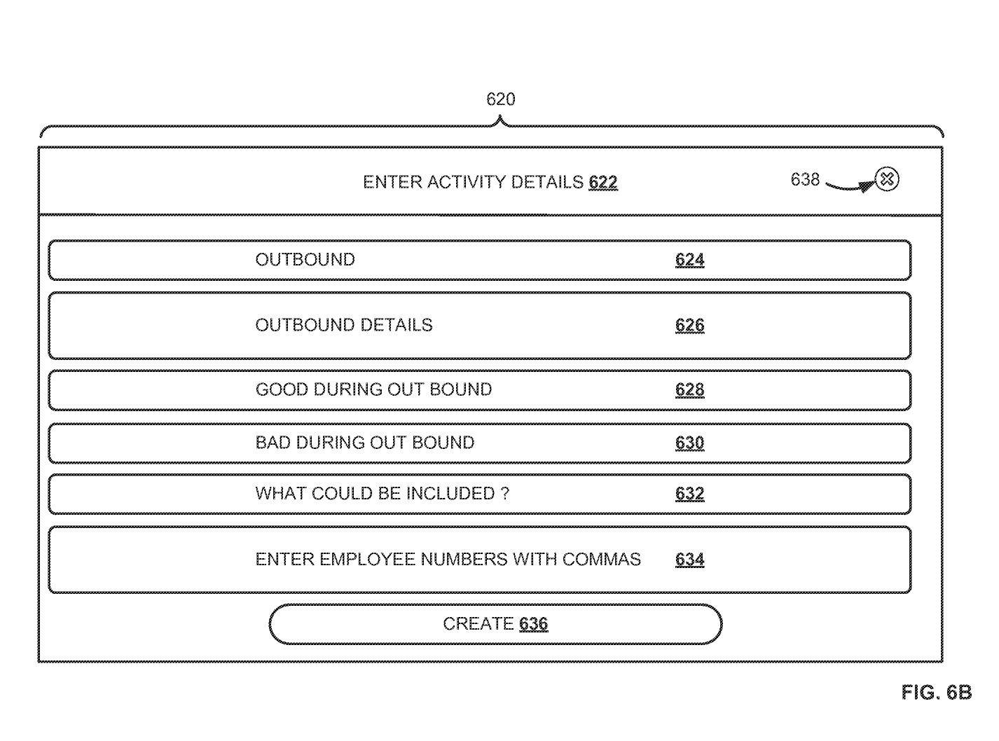

FIG. 6A is a block diagram showing a user interface provided by a collaborative application, according to an embodiment. By way of illustration, FIG. 6A shows user interface 602 for creating anew activity 604. The user interface 602 for creating new activity includes data fields, such as, “TITLE” 606, “DESCRIPTION” 608, “TITLE FOR GREEN CATEGORY” 610, “TITLE FOR RED CATEGORY” 612, “TITLE FOR YELLOW CATEGORY” 614, “ENTER EMPLOYEE NUMBERS WITH COMMAS (,)” 616, etc. In an embodiment, the “TITLE” 606 of the activity may be rendered on the list of activities and may be used to search for the activity. “DESCRIPTION” 608 may include a short description on the activity, The “TITLE FOR GREEN CATEGORY” 610, “TITLE FOR RED CATEGORY” 612, “TITLE FOR YELLOW CATEGORY” 614 may be used to categorize comments, feedbacks, suggestions, etc., associated with the activity. In the data field “ENTER EMPLOYEE NUMBERS WITH COMMAS (,)” 616, employee numbers of team members participating in the activity may be entered. In an embodiment, the employee numbers may be automatically populated, when the user starts entering the information in this data field (e.g., 616). In an embodiment, the collaborative application may communicate with an employee directory service to facilitate the automatic population of the data in this data field. Upon entering the information in their respective data fields (e.g., 606-616), the activity may be created by clicking on “CREATE” 618, The process of creating the activity may be canceled by clicking on 620. The created activity may be stored in the data store.

FIG. 6B is a block diagram showing a user interface provided by a collaborative application, according to an embodiment. In an embodiment, upon creating the activity (e.g., as explained in detailed description of FIG. 6A), the collaborative application provides user interface 620 to input more details associated with the activity (e.g., “ENTER ACTIVITY DETAILS” 622), By way of illustration, FIG. 613 shows user interface 620 including data fields, such as, “OUTBOUND” 624, representing the title of the activity “OUTBOUND DETAILS” 626, which receives user inputs; “GOOD DURING OUTBOUND” 628, “BAD DURING OUTBOUND” 630, “WHAT COULD BE INCLUDED?” 632, which may represent the user comment or suggestion or opinion or feedback; “ENTER EMPLOYEE NUMBERS WITH COMMAS (,)” 634, where employee number of team members participating in the activity may be entered. In an embodiment, the user opinion or feedback entered in the data fields 628 and/or 630 and/or 632 may be displayed in the dashboard as user interface elements (e.g., as a color coded post-it note, sticker, etc.). Upon entering the information in their respective data fields (e.g., 626-634), the activity details may be created by clicking on “CREATE” 636. The process of adding details for the activity may be canceled by clicking on 638. In an embodiment, the activity details may be stored in the data store. The activity details may be assigned with identifiers and may be rendered on the dashboard as user interfaces, user interface elements, etc., when the activity is selected.

In an embodiment, upon creating the new activity (e.g., as explained in detailed description of FIG. 6A) and entering additional details associated with the activity (e.g., as explained in details description of FIG. 6B), the e-mail service working in conjunction with the collaborative application may be triggered to send an e-mail to team members participating in the activity. By way of example, the team members participating in the activity may receive an e-mail confirming participation in the activity. In another embodiment, the team members may receive an invite with a link (e.g., a uniform resource locator (URL) associated with the activity) embedded in the e-mail to participate in the activity.

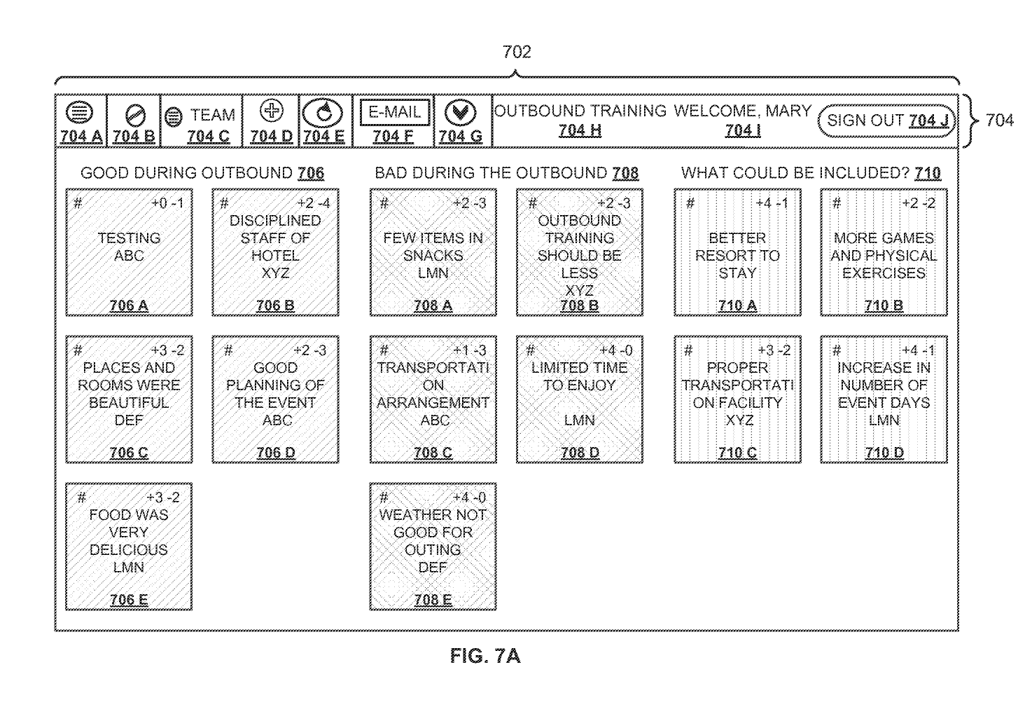

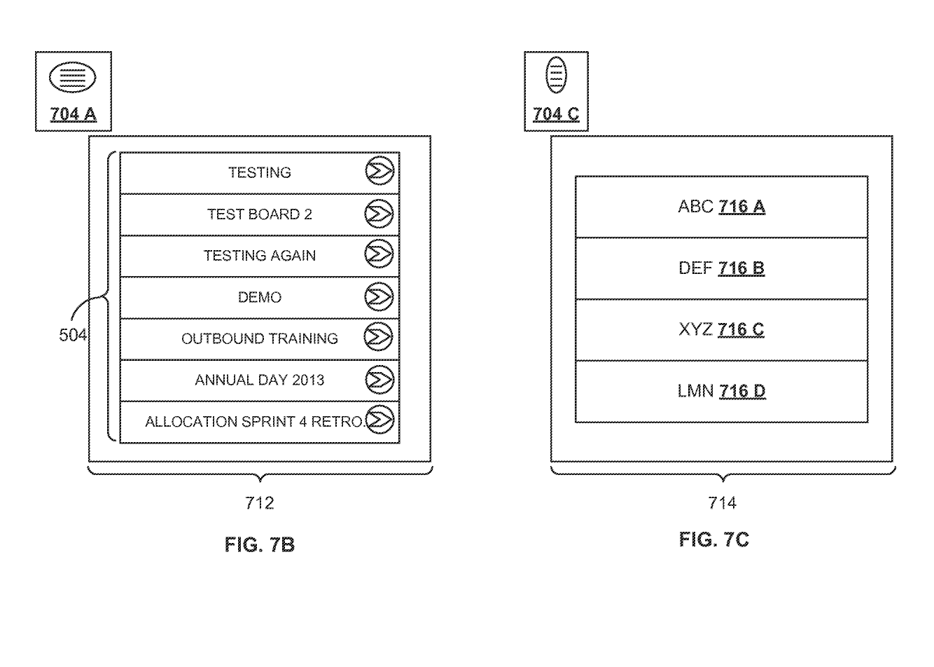

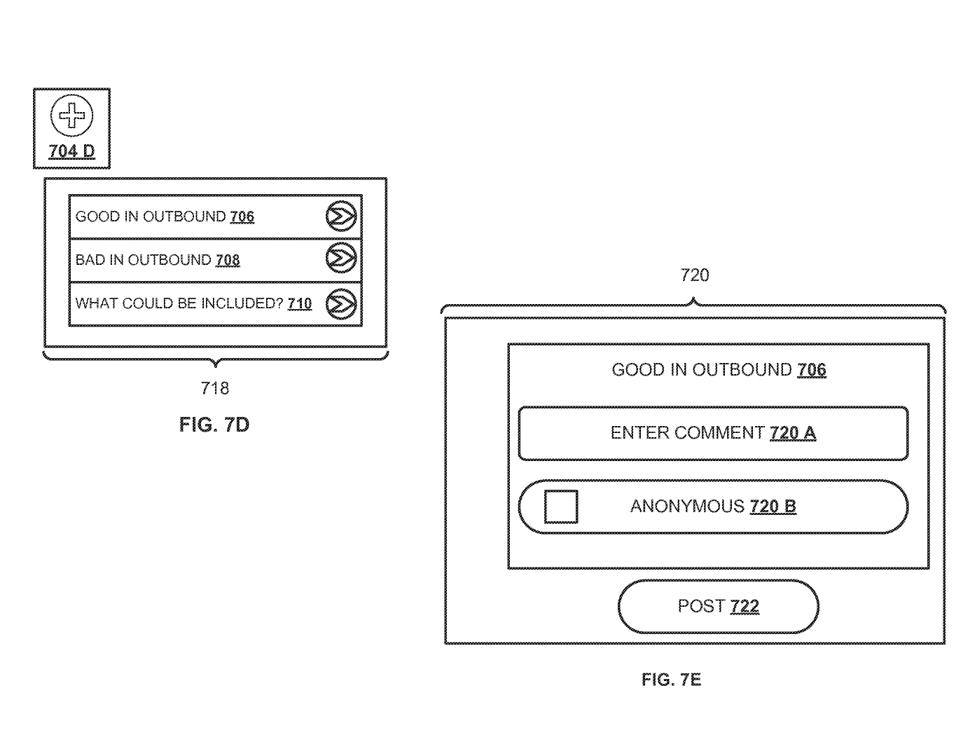

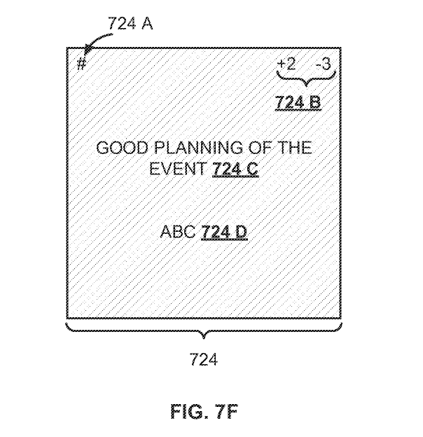

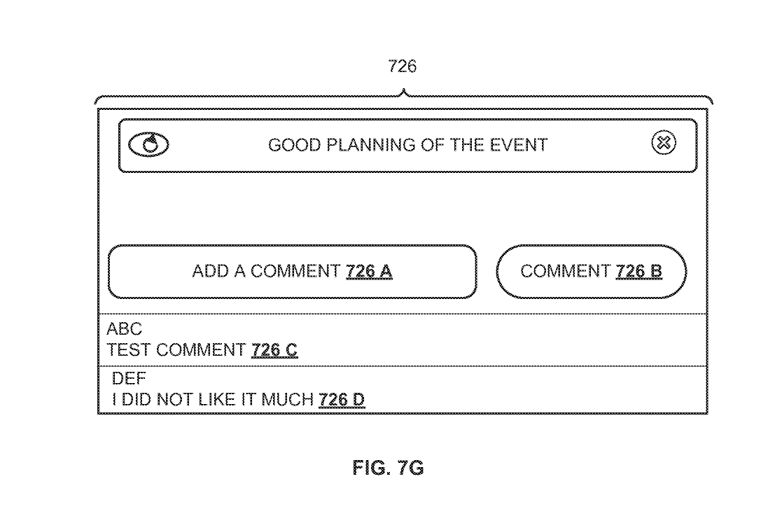

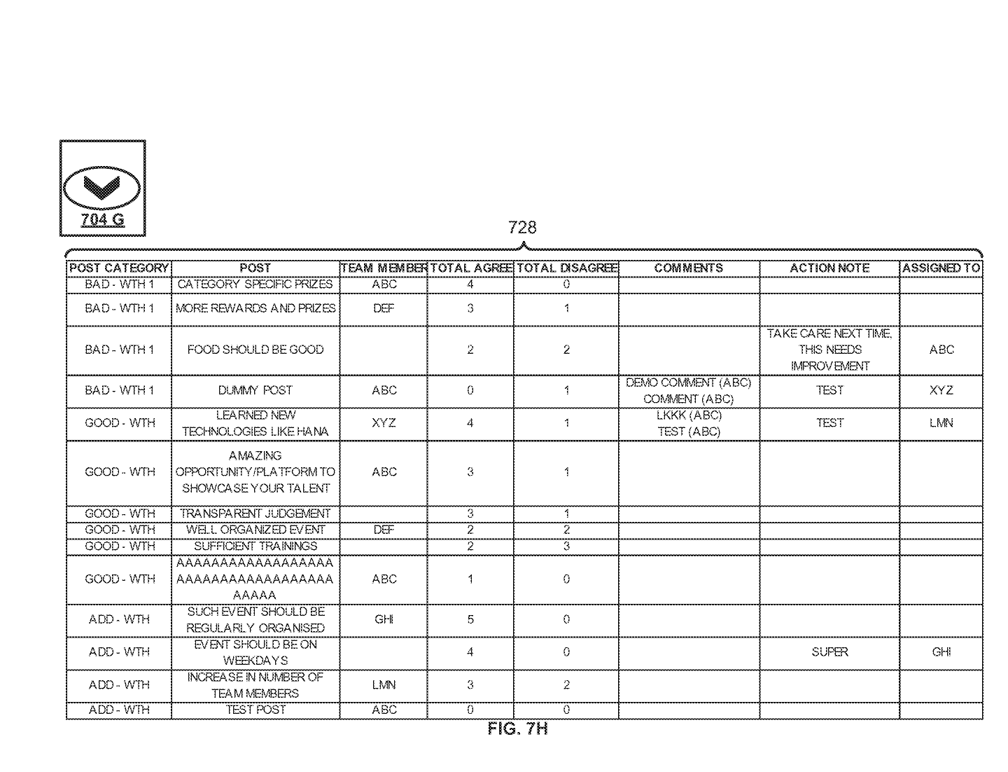

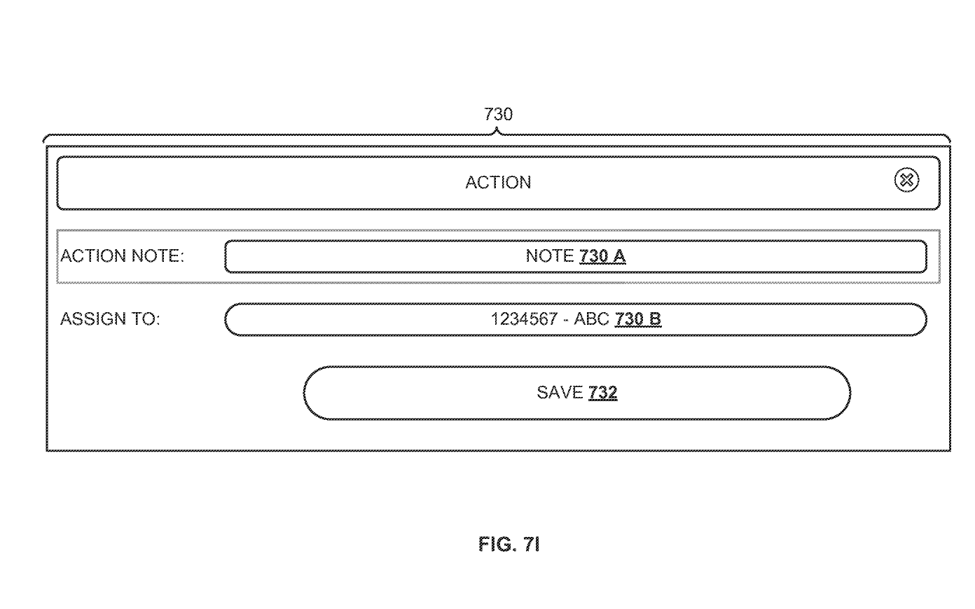

FIG. 7A is a block diagram showing a user interface provided by a collaborative application, according to an embodiment. By way of illustration, FIG. 7A shows user interface 702 rendering a dashboard associated with an activity (e.g., outbound training 704H). In an embodiment, the dashboard includes a tool bar 704 and multiple user interface elements. As explained previously, from the rendered list of activities (e.g., 504 in FIG. 5), an activity is selected. Upon selecting the activity (e.g., outbound training 704H), the collaborative application determines a correspondence between the selected activity, user interfaces, user interface elements, etc., associated with the activity. The user interface 702 rendering the dashboard associated with the selected activity (e.g., outbound training 704H) may be instantiated.

In an embodiment, the outbound training 704H activity may be created as explained in detailed description of FIG. 6A and FIG. 6B. By way of illustration, FIG. 7A shows categories, such as, “GOOD DURING OUTBOUND” 706, “BAD DURING THE OUTBOUND” 708,“WHAT COULD BE INCLUDED?” 710, etc. These categories may respectively correspond to “TITLE FOR GREEN CATEGORY” 610, “TITLE FOR RED CATEGORY” 612, “TITLE FOR YELLOW CATEGORY” 614 of FIG. 6A.

By way of illustration, FIG. 7A shows comments, suggestions, feedback, etc., that are provided by the team members participating in the activity. The comments, suggestions, feedback, etc., may be categorized (e.g., 706, 708 and 710) and rendered as user interface elements (e.g., color coded post-it note, stickers, etc. under each category. FIG. 7A shows that the comments, suggestions, feedback, etc., may be rendered as user interface elements that include 706A, 706B, 706C, 706D and 706E under the category “GOOD DURING OUTBOUND” 706; 708A, 708B, 708C, 708D and 708E under the category “BAD DURING THE OUTBOUND” 708; and 710A, 710B, 710C and 710D under the category “WHAT COULD BE INCLUDED?” 710. The toolbar 704 includes labels, such as, Dashboard Name (e.g., “OUTBOUND TRAINING” 704H), user name (e.g., “WELCOME, MARY” 704I) who is logged into the collaborative application, etc. The user may sign out of the collaborative application by clicking on “SIGN OUT” 704J.

In an embodiment, the user interface elements in the toolbar 704 includes: 704A that can be used (e.g., by an action, such as clicking) to navigate to different activities and associated dashboards; 704B that can be used to edit the activity (e.g., “OUTBOUND TRAINING” 704H) and or the associated dashboard. Upon clicking on 704B, user interface 620 of FIG. 6B may be instantiated, that may be used to edit the content/information related activity. In an embodiment, user interface element 704C can be used to instantiate a context menu that renders the list of team members participating in the activity; 704D that can be used to add comments, suggestions, feedback, etc., about the activity (e.g., “OUTBOUND TRAINING” 704H); 704E, that can be used to refresh the dashboard to render new comments, feedbacks, suggestions, etc.; 704F that can be used to send a consolidated e-mail to the team members participating in the activity (e.g., outbound training 704H); 704G that can be clicked to download the information rendered on the dashboard into a file (e.g., a text file, an excel file, a portable document format (pdf) file, etc.).

FIG. 7B is a block diagram showing a context menu associated with a tool bar of a dashboard, according to an embodiment. In an embodiment, upon clicking on user interface element 704A from tool bar 704 (e.g., FIG. 7A), context menu 712 is instantiated that renders a list of activities (e.g., 504 of FIG. 5) that may be accessible to a user. As explained previously, the list of activities may be rendered based on the attributes associated with the input credentials. On the context menu 712, the user may select, by clicking on the activity to navigate to the activity. In an embodiment, upon selecting the activity, a dashboard associated with the selected activity may be instantiated and rendered on the user interface.

FIG. 7C is a block diagram showing a context menu associated with a tool bar of a dashboard, according to an embodiment. In an embodiment, upon clicking on the user interface element 704C from tool bar 704 (e.g., FIG. 7), context menu 714 may be instantiated that renders a list of team members participating in the activity (e,g., “OUTBOUND TRAINING” 704H). By way of illustration, FIG. 7C shows context menu 714 rendering team members “ABC” 716A, “DEF” 716B, “XYZ” 716C, and “LMN” 716D as team members participating in the activity (e.g., “OUTBOUND TRAINING” 704H).

FIG. 7D is a block diagram showing a context menu associated with a tool bar of a dashboard, according to an embodiment. In an embodiment, upon clicking on the user interface element 704D from tool bar 704 (e.g., FIG. 7A), context menu 718 may be instantiated that be used to submit feedback, comments, suggestions, etc., for the activity. The user may select “GOOD IN OUTBOUND” 706, OR “BAD IN OUTBOUND” 708 OR “WHAT COULD BE INCLUDED?” 710, from the instantiated context menu 718 to post a comment, feedback, suggestion, etc.

FIG. 7E is a block diagram showing user interface provided by a collaborative application, according to an embodiment. By way of example, upon selecting “GOOD IN OUTBOUND” 706 from the instantiated context menu 718, a user interface 720 may be provided by the collaborative application. In an embodiment, the user may submit his/her opinion by entering comments, suggestions, feedback, etc., in data field 720A in the user interface 720. The user may choose to submit his/her opinion anonymously by clicking the check box “ANONYMOUS” 720 B on the user interface 720. If the user does not opt to post anonymously, his/her name may be rendered with the comment, suggestion, feedback, etc., posted. The comment, suggestion, feedback, etc., may be posted by clicking on “POST” 722 that may be associated with the activity and stored in the data store.

FIG. 7F is a block diagram showing a user interface element rendered on a. dashboard of a collaborative application, according to an embodiment. By way of illustration, FIG. 7F shows a comment or suggestion 724C rendered as a user interface element 724 on a dashboard, in an embodiment, user interface element 724 includes a “MENU” 724A indicated by ‘#’ sign on 724; a provision (e.g., 724B) to agree (indicated by ‘+’ sign in 724B) or disagree (indicated by a sign in 724B) on the comment or suggestion 724C; and name of the team member (e.g., “ABC” 724D) who has posted the comment or suggestion 724C.

FIG. 7G is a block diagram showing a user interface provided by a collaborative application, according to an embodiment. In an embodiment, upon clicking on “MENU” 724A, indicated by ‘#’ sign on 724 of FIG. 7F, user interface 726 may be provided by the collaborative application. A team member participating in the activity may provide his/her feedback on a comment or suggestion 724C that is posted by another team member participating in the activity. The team member may input his/her comment in “ADD A COMMENT” 726A and click on “COMMENT” 726B to submit his/her comment on the feedback or suggestion 724C. By way of illustration, FIG. 7G shows comments 726C and 726D posted by other team members (e.g., “ABC” and “DEF”) participating in the activity (e.g., “OUTBOUND TRAINING” 704H of FIG. 7A).

FIG. 7H is a table showing exemplary information associated with an activity, according to an embodiment. In an embodiment, upon clicking on the user interface element 704G from tool bar 704 (e.g., FIG. 7A), the information associated with the activity rendered on user interface 702 may be downloaded into a file (e.g., a flat file, an excel spreadsheet, etc.). By way of illustration, FIG. 7H shows that the information associated with the activity is downloaded and into a spread sheet 728. The data (e.g., comments, suggestions, feedback, etc.) in the spread sheet 728 may represent consolidated information and such consolidated information may be e-mailed to the team members participating in the event.

FIG. 7I is a block diagram showing user interface provided by a collaborative application, according to an embodiment. By way of example, a user interface 730 may be provided by the collaborative application. In an embodiment, an action item may be assigned to a user via the user interface 730. In the data field “ACTION NOTE”, a “NOTE” 730A including description of the action item may be entered. In the data field labeled “ASSIGN TO”, an end user may select or enter details of a team member participating in the activity user (e.g. “ABC”-730 B). The action item assigned to the user may be saved to the data store by clicking on “SAVE” 732.

Some embodiments may include the above-described methods being written as one or more software components. These components, and the associated functionality, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”), Read-only-Memory (ROM) and Random Access Memory (RAM) devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

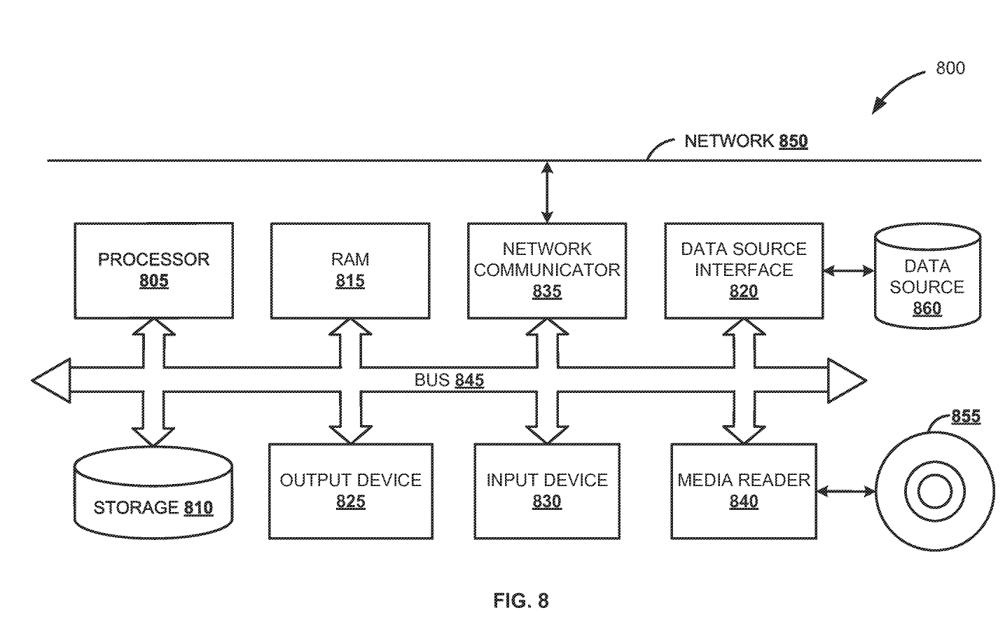

FIG. 8 is a block diagram of an exemplary computer system 800, according to an embodiment. Computer system 800 includes processor 805 that executes software instructions or code stored on computer readable storage medium 855 to perform the above-illustrated methods. Processor 805 can include a plurality of cores. Computer system 800 includes media reader 840 to read the instructions from computer readable storage medium 855 and store the instructions in storage 810 or in RAM 815. Storage 810 provides a large space for keeping static data where at least sonic instructions could be stored for later execution. According to some embodiments, such as some in-memory computing system embodiments, RAM 81:5 can have sufficient storage capacity to store much of the data required for processing in RAM 815 instead of in storage 810. In some embodiments, the data required for processing may be stored in RAM 815. The stored instructions may be further compiled to generate other representations of the instructions and dynamically stored in RAM 815. Processor 805 reads instructions from RAM 815 and performs actions as instructed. According to one embodiment, computer system 800 further includes output device 825 (e.g., a display) to provide at least some of the results of the execution as output including, but not limited to, visual information to users and input device 830 to provide a user or another device with means for entering data and/or otherwise interact with computer system 800. Output devices 825 and input devices 830 could be joined by one or more additional peripherals to further expand the capabilities of computer system 800. Network communicator 835 may be provided to connect computer system 800 to network 850 and in turn to other devices connected to network 850 including other clients, servers, data stores, and interfaces, for instance. The modules of computer system 800 are interconnected via bus 845. Computer system 800 includes a data source interface 820 to access data source 860. Data source 860 can be accessed via one or more abstraction layers implemented in hardware or software. For example, data source 860 may be accessed by network 850. In some embodiments data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., eXtensible Markup Language or XML data), transactional data, unstructured data (e.g., text files, screen scrapings), hierarchical data (e.g., data in a file system, XML, data), files, a plurality of reports, and any other data source accessible through an established protocol, such as, Open Data Base Connectivity (ODBC), produced by an underlying software system (e.g., Enterprise Resource Planning system), and the like. Data sources may also include a data source where the data is not tangibly stored or otherwise ephemeral such as data streams, broadcast data, and the like. These data sources can include associated data foundations, semantic layers, management systems security systems and so on.

to the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to manage activities in an organization, comprising:
upon establishing a connection with a data store via a collaborative application, providing a first user interface to receive one or more input credentials;
based on one or more attributes associated with the one or more input credentials, providing a second user interface to render a list of activities;
upon receiving a selection of at least one activity from the rendered list of activities, a processor of a computer determining a correspondence between the selected at least one activity and one or more associated dashboards, wherein the one or more associated dashboards include one or more associated user interfaces and one or more associated user interface elements; and
instantiating at least one dashboard of the one or more associated dashboards via the collaborative application, to manage the selected at least one activity.

2. The computer implemented method of claim 1, wherein determining the correspondence between the selected at least one activity, the one or more associated user effaces and the one or more associated user interface elements, comprises:
comparing one or more identifiers associated with the selected activity, the at least one dashboard, the one or more associated user interfaces, and the one or more associated user interface elements: and
determining one or more identical identifiers associated with the selected at least one activity, the at least one dashboard, the one or more associated user interfaces, and the one or more associated user interface elements.

3. The computer implemented method of claim 2, wherein the one or more identifiers associated with the at least one selected activity is selected from a group consisting of the one or more input credentials, a business unit code, a project code, and a project team code.

4. The computer implemented method of claim 1, wherein the one or more associated user interface elements is selected from a group consisting of one or more graphical control elements, one or more application launchers, one or more animated graphical elements, and one or more icons.

5. The computer implemented method of claim 1, further comprising: based on the one or more attributes associated with the one or more input credentials, determining an access control to one or more activities from the list of activities.

6. The computer implemented method of claim 1, wherein the determination of the correspondence between the selected at least one activity and the one or more associated user interface elements includes filtering the one or more associated user interface elements based on the selected at least one activity and the one or more attributes associated with the one or more input credentials.

7. The computer implemented method of claim 1, further comprising: generating an e-mail by an e-mail service working in conjunction with the collaborative application.

8. A computer system to manage activities in an organization,comprising;
a processor; and
one or more memory devices communicatively coupled with the processor and the one or more memory devices storing instructions related to:
upon establishing a connection with a data store via a collaborative application, providing a first user interface to receive one or more input credentials;
based on one or more, attributes associated with the one or more input credentials providing a second user interface rendering a list of activities;
upon receiving a selection of at least one activity from the rendered list of activities, determining a correspondence between the selected at least one activity and one or more associated dashboards, wherein the one or more associated dashboards include one or more associated user interfaces and one or more associated user interface elements; and
instantiating at least one dashboard of the one or more associated dashboards via the collaborative application to manage the selected at least one activity.

9. The computer system of claim 8, wherein determining the correspondence between the selected at least one activity, the one or more associated user interfaces and the one or more associated user interface elements, comprises:
comparing one or more identifiers associated with the selected activity, the at least one dashboard, the one or more associated user interfaces, and the one or more associated user interface elements: and
determining one or more identical identifiers associated with the selected at least one activity, the at least one dashboard, the one or more associated user interfaces, and the one or more associated user interface elements.

10. The computer system of claim 8, wherein the one or more identifiers associated with the at least one selected activity is selected from a group consisting of the one or more input credentials, a business unit code, a project code, and a project team code.

11. The computer system of claim 8, wherein the one or more associated user interface elements is selected from a group consisting of one or more graphical control elements, one or more application launchers, one or more animated graphical elements, and one or more icons.

12. The computer system of claim 8, further comprising: based on the one or more attributes associated with the one or more input credentials, determining an access control to one or more activities from the list of activities.

13. The computer system of claim 8, wherein the determination of the correspondence between the selected at least one activity and the one or more associated user interface elements includes filtering the one or more associated user interface elements based on the selected at least one activity and the one or more attributes associated with the one or more input credentials.

14. A non-transitory computer readable storage medium tangibly storing instructions, which when executed by a computer, cause the computer to execute operations comprising:
upon establishing a connection with a data store via a collaborative application, provide a first user interface to receive one or more input credentials;
based on one or more attributes associated with the one or more input credentials, provide a second user interface rendering a list of activities;
upon receiving a selection of at least one activity from the rendered list of activities, determine a correspondence between the selected at least one activity and one of more associated dashboards, wherein the one or more associated dashboards include one or more associated user interfaces and one or more associated user interface elements; and
instantiate at least one dashboard of the one or more associated dashboards via the collaborative application, to manage the selected at least one activity.

15. The non-transistory computer readable storage medium of claim 14, wherein determining the correspondence between the selected at least one activity, the one or more associated user interfaces and the one or more associated user interface elements, comprises:
comparing one or more identifiers associated with the selected activity, the at least one dashboard, the one or more associated user interfaces, and the one or more associated user interface elements; and
determining one or more identical identifiers associated with the selected at least one activity, the at least one dashboard, the one or more associated user interfaces, and the one or more associated user interface elements.

16. The non-transitory computer readable storage medium of claim 14, wherein the one or more identifiers associated with the at least one selected activity is selected from a group consisting of the one or more input credentials, a business unit code, a project code, and a project team code.

17. The non-transitory computer readable storage medium of claim 14, wherein the one or more associated user interface elements is selected from a group consisting of one or more graphical control elements, one or more application launchers, one or more animated graphical elements, and one or more icons.

18. The non-transitory computer readable storage medium of claim 14, further comprising instructions which when executed by a computer, cause the computer to further execute operations, comprising: based on the one or more attributes associated with the one or more input credentials, determine an access control to one or more activities from the list of activities.

19. The non-transitory computer readable storage medium of claim 14, wherein the determination of the correspondence between the selected at least one activity and the one or more associated user interface elements includes filtering the one or more associated user interface elements based on the selected at least one activity and the one or more attributes associated with the one or more input credentials.

20. The non-transitory computer readable storage medium of claim 14, further comprising instructions which when executed by a computer, cause the computer to further execute operations, comprising: generating an e-mail by an e-mail service working in conjunction with the collaborative application.
